(19) United States
(12) Patent Application Publication
(10) Pub. No.: US 2010/0277415 A1
(43) Pub. Date: Nov. 4, 2010

(54) MULTIMEDIA MODULE FOR A MOBILE COMMUNICATION DEVICE

(75) Inventors: Rajeev Rema SHANMUGAM, Chennai (IN); Mohanraj MANOHARAN, Chennai (IN)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/433,346

(22) Filed: Apr. 30, 2009

(51) Int. Cl. G06F 3/02; G06F 3/041

(52) U.S. Cl. 345/169; 345/173

(57) ABSTRACT

A mobile communication device includes a touch screen device, and a multimedia module that moveably connects to the touch screen device. The multimedia module includes a first input or output mechanism provided at a first location of the multimedia module that is below the touch screen device. The first input or output mechanism is moveable from the first location to above a first end portion of the touch screen device. The multimedia module also includes a second input or output mechanism provided at a second location of the multimedia module that is below the touch screen device. The second input or output mechanism is moveable from the second location to above a second end portion of the touch screen device.

### BACKGROUND

Devices, such as mobile communication devices (e.g., cell phones, personal digital assistants (PDAs), etc.), include touch sensitive input devices (e.g., touch sensitive interfaces or displays, touch screens, etc.). Touch screens are usually formed with either a resistive or capacitive film layer, located above a display, which is used to sense a touch of the user's finger or a stylus. Some touch screens enable the user to input information (e.g., text, numbers, etc.), play multimedia (e.g., music, games, video, etc.), etc. via interaction with information displayed on the touch screen. However, such touch screen-based mobile communication devices do not provide additional multimedia components (e.g., multimedia keys, keypads, etc.) for the user to play multimedia via the mobile communication devices.

### SUMMARY

According to one aspect, a mobile communication device may include a touch screen device, and a multimedia module that moveably connects to the touch screen device, where the multimedia module may include a first input or output mechanism provided at a first location of the multimedia module that is below the touch screen device, where the first input or output mechanism is moveable from the first location to above a first end portion of the touch screen device, and a second input or output mechanism provided at a second location of the multimedia module that is below the touch screen device, where the second input or output mechanism is moveable from the second location to above a second end portion of the touch screen device.

Additionally, the mobile communication device may include one or more of a radiotelephone, a personal communications system (PCS) terminal, a personal digital assistant (PDA), a portable gaming system, or a global positioning system (GPS) device.

Additionally, the touch screen device may include a housing, a display supported by the housing, and a sensing layer to detect an input object.

Additionally, the multimedia module may be removable from the touch screen device.

Additionally, when the touch screen device is moved in a first direction, the first input or output mechanism may be exposed and may be moveable from the first location to above the first end portion of the touch screen device.

Additionally, when the touch screen device is moved in a second direction that is opposite to the first direction, the second input or output mechanism may be exposed and may be moveable from the second location to above the second end portion of the touch screen device.

Additionally, the first input or output mechanism may include a keypad.

Additionally, the keypad may include one or more of one or more keys, a pointer device, a touch pad, or a camera.

Additionally, the first input or output mechanism may include a speaker.

Additionally, the second input or output mechanism may include a keypad.

Additionally, the keypad may include one or more of one or more keys, a pointer device, a touch pad, or a camera.

Additionally, the second input or output mechanism may include a speaker.

According to another aspect, a system may include a touch screen mobile communication device, and a multimedia module that moveably connects to the touch screen mobile communication device, where the multimedia module may include a first input mechanism provided at a first location of the multimedia module that is below the touch screen mobile communication device, where the first input mechanism is moveable from the first location to above a first end portion of the touch screen mobile communication device, and a second input mechanism provided at a second location of the multimedia module that is below the touch screen mobile communication device, where the second input mechanism is moveable from the second location to above a second end portion of the touch screen mobile communication device.

Additionally, the touch screen mobile communication device may include one or more of a radiotelephone, a personal communications system (PCS) terminal, a personal digital assistant (PDA), a portable gaming system, or a global positioning system (GPS) device.

Additionally, the multimedia module may be a removable and distinct component from the touch screen mobile communication device.

Additionally, when the touch screen mobile communication device is moved in a first direction, the first input mechanism may be exposed and may be moveable from the first location to above the first end portion of the touch screen mobile communication device.

Additionally, when the touch screen mobile communication device is moved in a second direction that is opposite to the first direction, the second input mechanism may be exposed and may be moveable from the second location to above the second end portion of the touch screen mobile communication device.

Additionally, each of the first input mechanism and the second input mechanism may include a keypad that includes one or more of one or more keys, a pointer device, a touch pad, or a camera.

According to yet another aspect, a mobile communication device may include a touch screen device, and a multimedia module that moveably connects to the touch screen device, where the multimedia module may include a first output mechanism provided at a first location of the multimedia module that is below the touch screen device, where the first output mechanism is moveable from the first location to above a first end portion of the touch screen device, and a second output mechanism provided at a second location of the multimedia module that is below the touch screen device, where the second output mechanism is moveable from the second location to above a second end portion of the touch screen device.

Additionally, each the first output mechanism and the second output mechanism may include a speaker.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 depicts a diagram of an exemplary device in which systems and/or methods described herein may be implemented;

FIG. 2 illustrates a diagram of exemplary components of the device depicted in FIG. 1;

FIG. 3 depicts a diagram of exemplary components of a display (e.g., a touch screen) of the device illustrated in FIG. 1;

FIGS. 4A-4F illustrate diagrams of exemplary configurations of a multimedia module of the device depicted in FIG. 1;

FIG. 5A depicts a diagram of an exemplary top plan view of the device illustrated in FIG. 1;

FIG. 5B illustrates a diagram of an exemplary front view of the device depicted in FIG. 1, taken along line 5B-5B of FIG. 5A;

FIG. 5C depicts a diagram of an exemplary side view of the device illustrated in FIG. 1, taken along line 5C-5C of FIG. 5A; and

FIG. 6 illustrates a flow chart of an exemplary process for interacting with the device depicted in FIG. 1 according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

### Overview

Systems and/or methods described herein may enhance a multimedia and/or gaming experience for a user of a mobile communication device (e.g., a cell phone, a PDA, etc.) that may include a touch screen device (e.g., a display). In one implementation, for example, the systems and/or methods may move a touch screen device (e.g., of a mobile communication device) in a first direction to expose a first keypad, and may move the first keypad above the touch screen device. The systems and/or methods may move the touch the screen device in a second direction to provide the touch screen device under the first keypad and to expose a second keypad, and may move the second keypad above the touch screen device. The systems and/or methods may move the touch screen device in the first direction to provide the touch screen device under a portion of the first keypad and under a portion of the second keypad.

As used herein, the term “user” is intended to be broadly interpreted to include a mobile communication device or a user of a mobile communication device. The term “touch screen,” as used herein, is intended to be broadly interpreted to include a touch screen display, a touch sensitive input device, a touch sensitive interface, etc.

### Exemplary Device Architectures

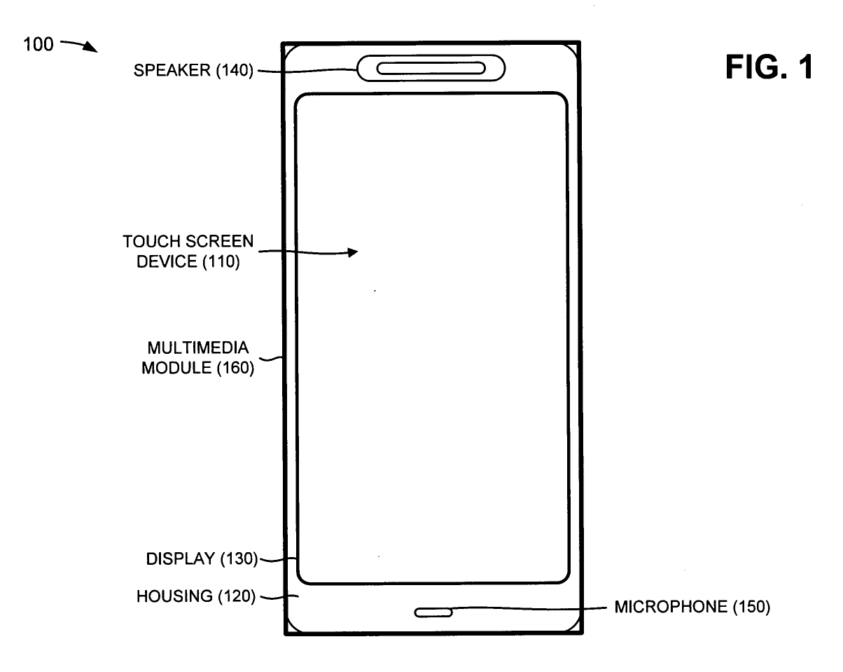

FIG. 1 is a diagram of an exemplary mobile communication device (hereinafter referred to as “device 100”) in which systems and/or methods described herein may be implemented. Device 100 may include a radiotelephone, a personal communications system (PCS) terminal (e.g., that may combine a cellular radiotelephone with data processing and data communications capabilities), a PDA (e.g., that can include a radiotelephone, a pager, Internet/intranet access, etc.), a portable gaming system, a global positioning system (GPS) device, any other mobile communication device capable of utilizing a touch screen display, a thread or process running on one of these devices, and/or an object executable by one of these devices. As illustrated in FIG. 1, device 100 may include a touch screen device 110 (e.g., that includes a housing 120, a display 130, a speaker 140, and/or a microphone 150) and a multimedia module 160.

Touch screen device 110 may include a touch screen display, a touch sensitive input device, a touch sensitive interface, a touch screen mobile communication device (e.g., a radiotelephone, a PCS terminal, a PDA, a portable gaming system, a GPS device, etc.), etc. In one implementation, touch screen device 110 may be replaced with a non-touch screen device, such as a non-touch screen display, a non-touch screen radiotelephone, PCS terminal, PDA, portable gaming system, GPS device, etc.

Housing 120 may protect the components of touch screen device 110 from outside elements. Housing 120 may include a structure configured to hold devices and components used in touch screen device 1 10, and may be formed from a variety of materials. For example, housing 120 may be formed from plastic, metal, or a composite, and may be configured to support display 130, speaker 140, and/or microphone 150. In one implementation, housing 120 may be configured to connect with (e.g., in a sliding manner) multimedia module 160.

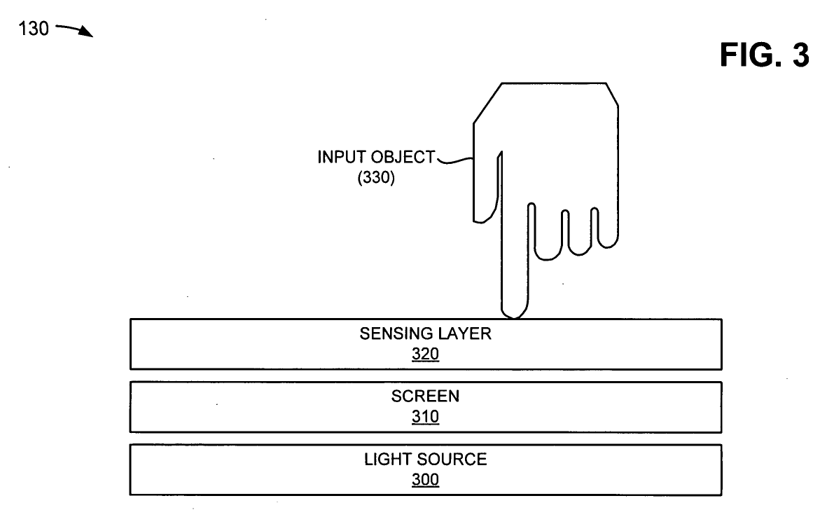

Display 130 may provide visual information to the user. For example, display 130 may display text input into device 100; text, images, video, and/or graphics received from another device; and/or information regarding incoming or outgoing calls or text messages, emails, media, games, phone books, address books, the current time, etc. In one implementation, display 130 may include a touch screen display that may be configured to receive a user input when the user touches display 130. For example, the user may provide an input to display 130 directly, such as via the user's finger, or via other input objects, such as a stylus. User inputs received via display 130 may be processed by components and/or devices operating in device 100. The touch screen display may permit the user to interact with device 100 in order to cause device 100 to perform one or more operations. Further details of display 130 are provided below in connection with, for example, FIG. 3.

Speaker 140 may provide audible information to a user of device 100. Speaker 140 may be located in an upper portion of touch screen device 110, and may function as an ear piece when a user is engaged in a communication session using device 100. Speaker 140 may also function as an output device for music and/or audio information associated with games and/or video images played on device 100.

Microphone 150 may receive audible information from the user. Microphone 150 may include a device that converts speech or other acoustic signals into electrical signals for use by device 100. Microphone 150 may be located proximate to a lower side of touch screen device 110.

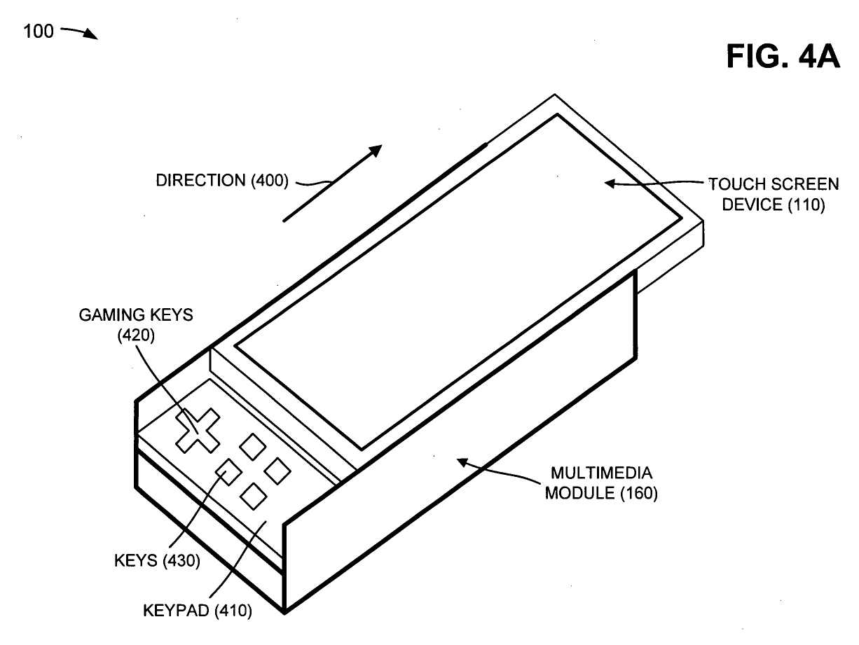

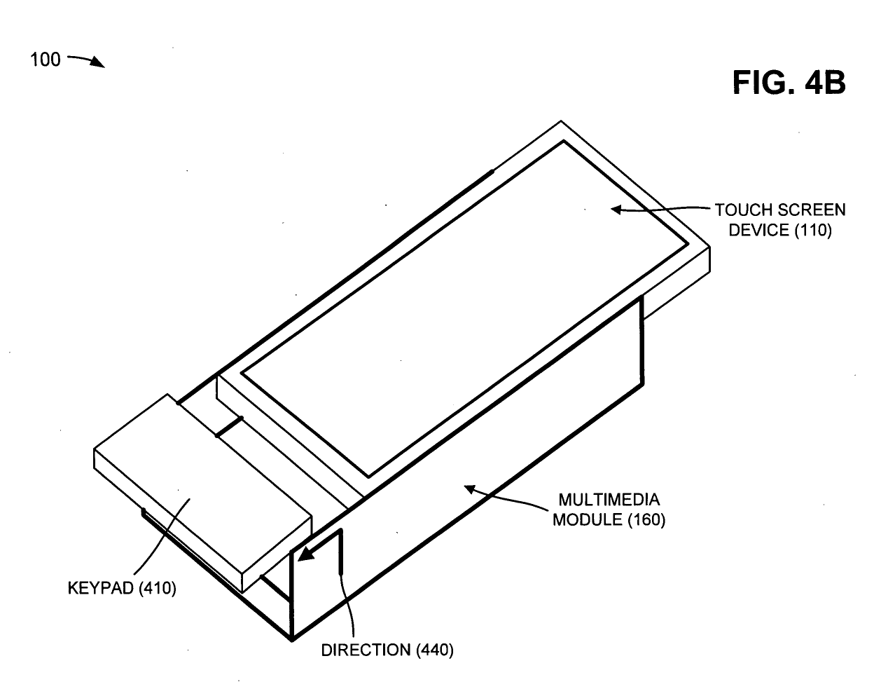

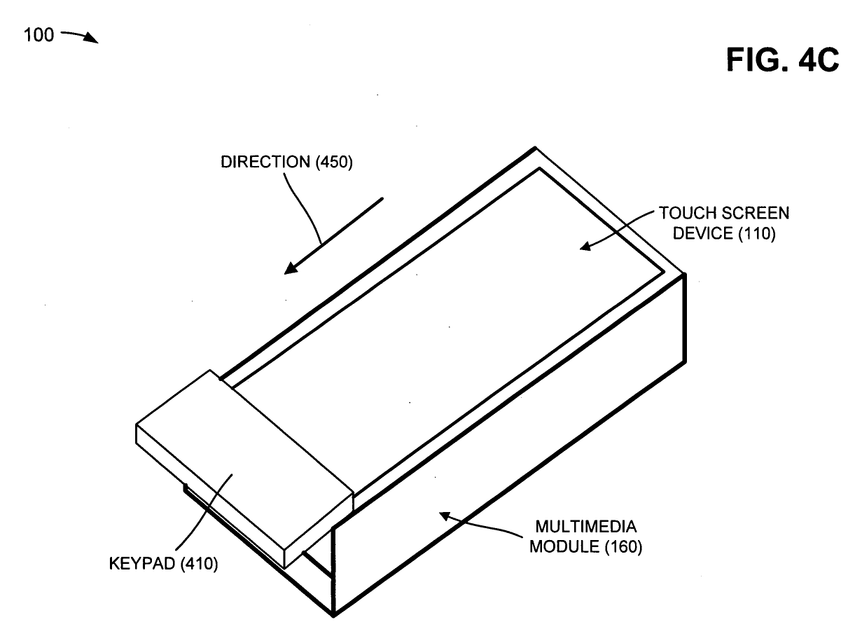

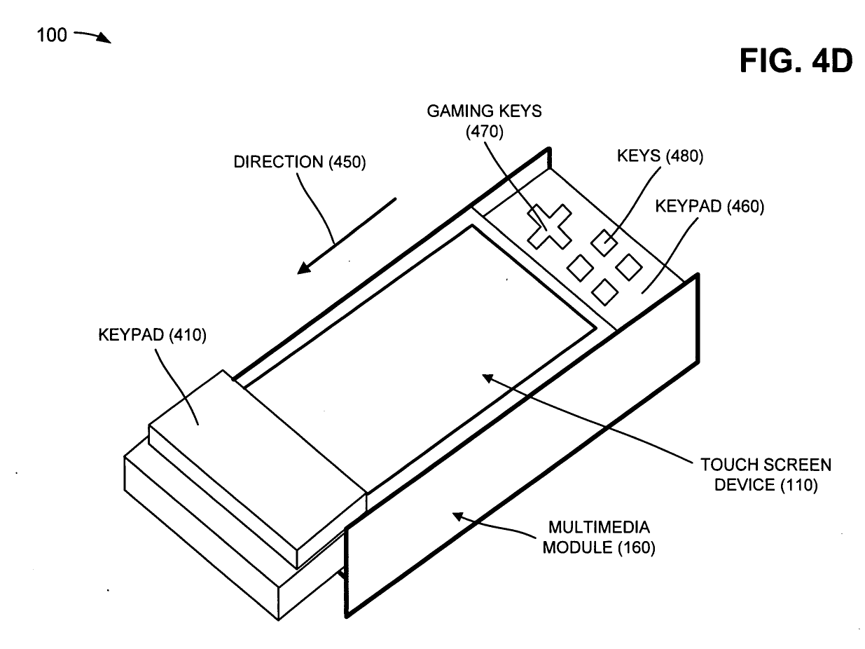

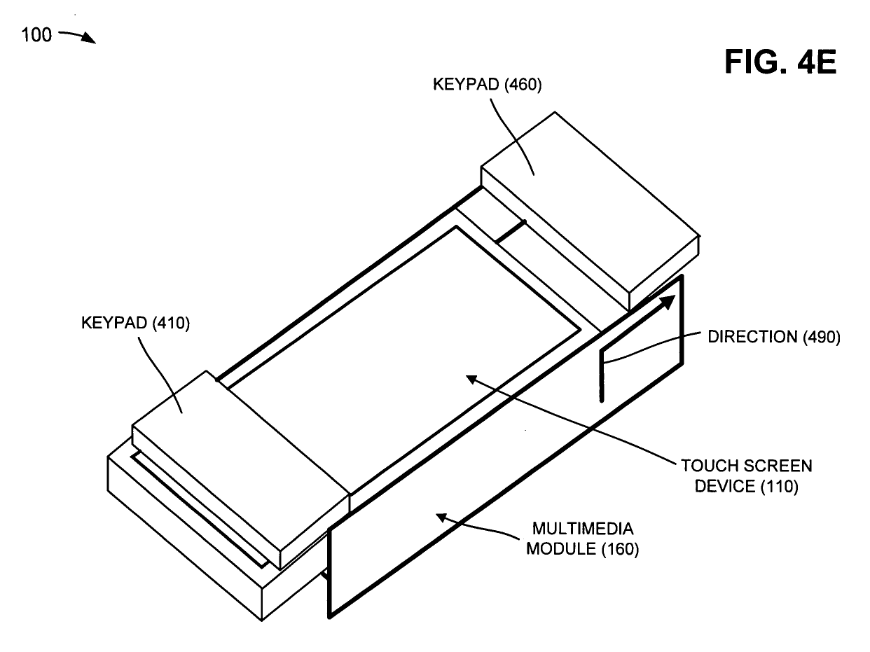

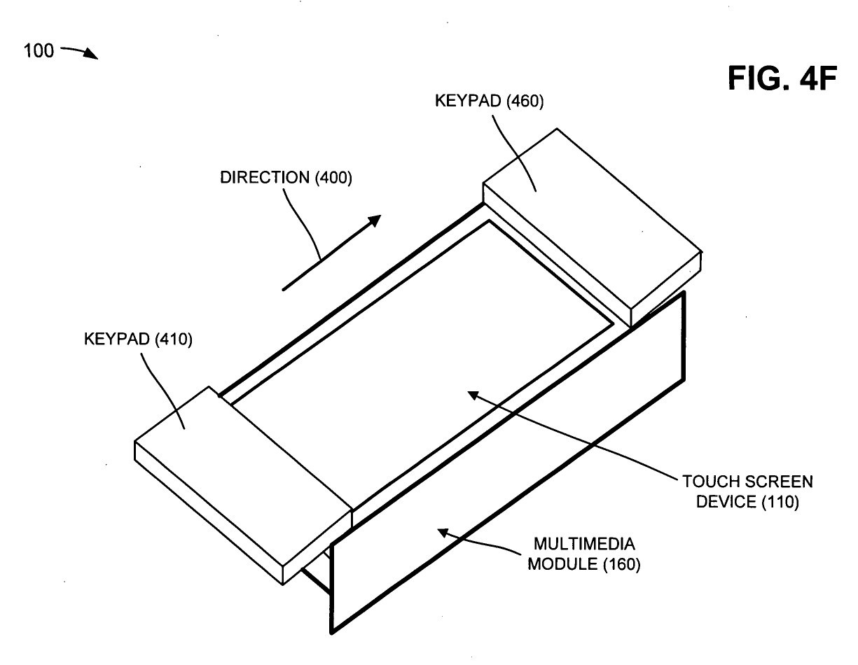

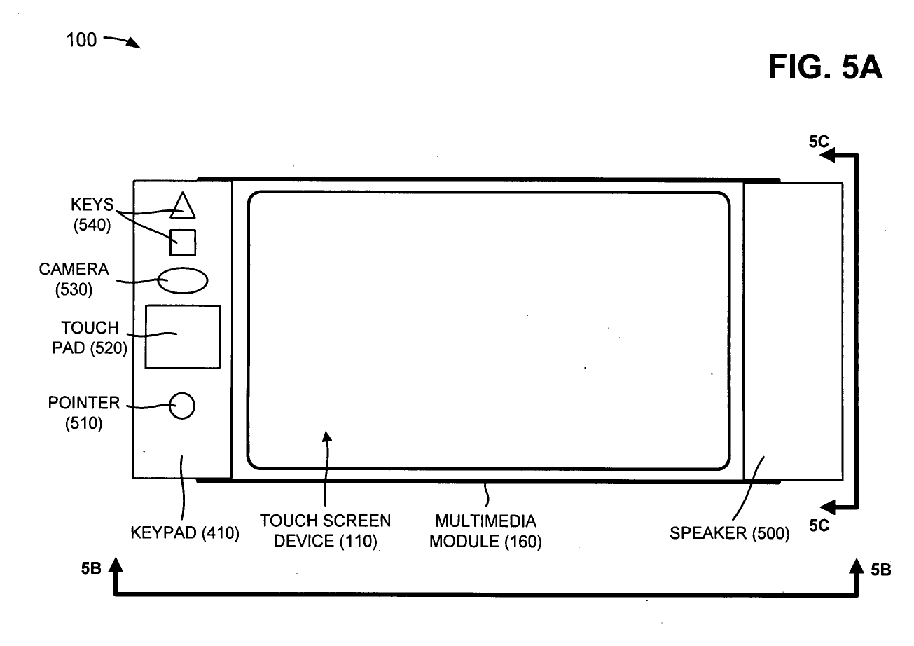

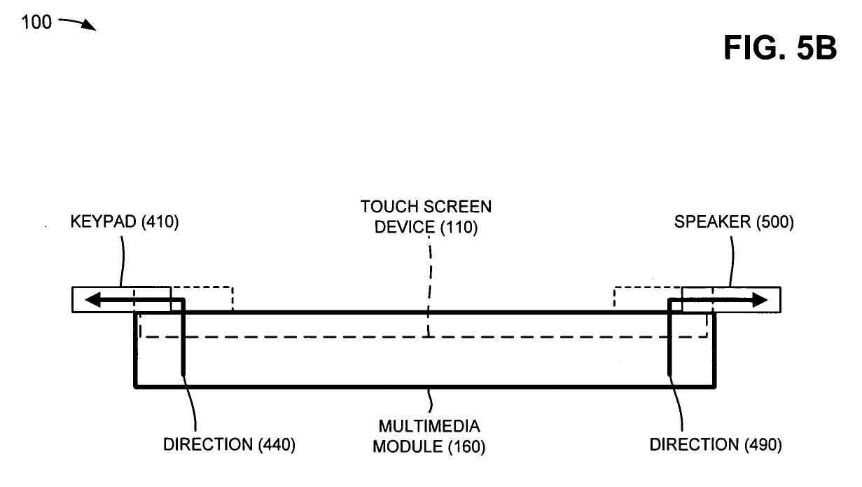

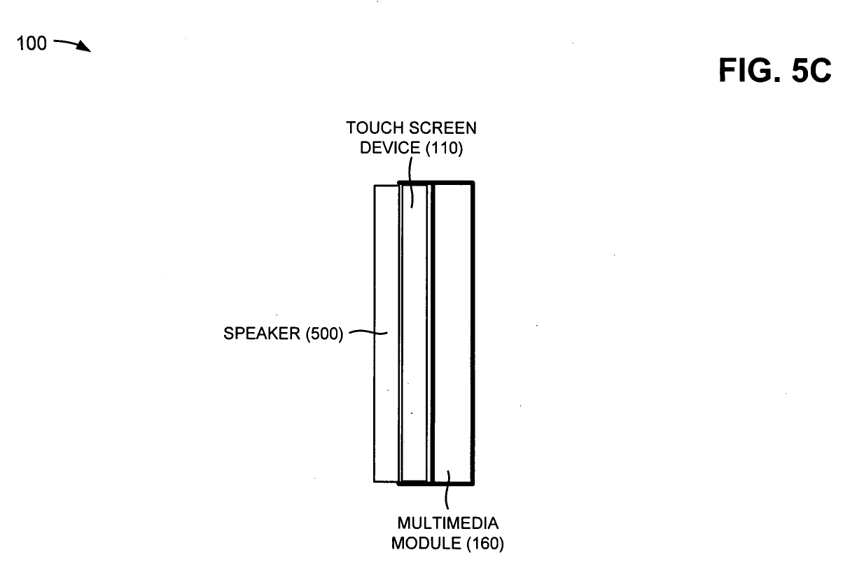

Multimedia module 160 may include a module that contains multimedia input and/or output devices for providing inputs/outputs to/from device 100. For example, multimedia module 160 may include multimedia keypads, keys, speakers, etc. In one implementation, multimedia module 160 may be a separate and distinct component (e.g., that is attachable, detachable, and removable) from touch screen device 110, and may mechanically connect with (and disconnect from) touch screen device 110 (e.g., via a connection (e.g., bearings, grooves, etc.) that enables touch screen device 110 to slide along a length of multimedia module 160). In such an arrangement, the multimedia input and/or output devices of multimedia module 160 may communicate with touch screen device 110 via wired and/or wireless connections. In another implementation, touch screen device 110 and multimedia module 160 may be integrated components of device 100. In such an arrangement, touch screen device 110 may be moveable (e.g., via a connection that enables touch screen device 110 to slide along the length of multimedia module 160) with respect to multimedia module 160, and the multimedia input and/or output devices of multimedia module 160 may communicate with touch screen device 110 via wired and/or wireless connections. Further details of multimedia module 160 are provided below in connection with, for example, FIGS. 4A-5C.

Although FIG. 1 shows exemplary components of device 100, in other implementations, device 100 may contain fewer, different, differently arranged, or additional components than depicted in FIG. 1. In still other implementations, one or more components of device 100 may perform one or more other tasks described as being performed by one or more other components of device 100.

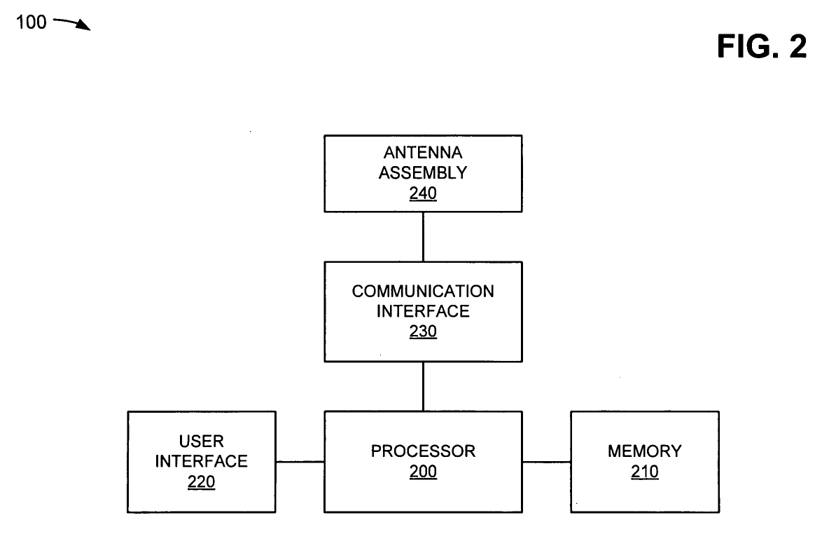

FIG. 2 illustrates a diagram of exemplary components of device 100. As illustrated, device 100 may include a processor 200, memory 210, a user interface 220, a communication interface 230, and/or an antenna assembly 240.

Processor 200 may include one or more microprocessors, application-specific integrated circuits (ASICs), field-programmable gate arrays (FPGAs), or the like. Processor 200 may control operation of device 100 and its components. In one implementation, processor 200 may control operation of components of device 100 in a manner described herein.

Memory 210 may include a random access memory (RAM), a read-only memory (ROM), and/or another type of memory to store data and instructions that may be used by processor 200.

User interface 220 may include mechanisms for inputting information to device 100 and/or for outputting information from device 100. Examples of input and output mechanisms might include buttons (e.g., control buttons, keys of a keypad, a joystick, etc.) or a touch screen interface (e.g., touch screen device 110) to permit data and control commands to be input into device 100; a speaker (e.g., speaker 140) to receive electrical signals and output audio signals; a microphone (e.g., microphone 150) to receive audio signals and output electrical signals; a display (e.g., display 130) to output visual information (e.g., text input into device 100); a vibrator to cause device 100 to vibrate; the multimedia input and/or output devices of multimedia module 160; etc.

Communication interface 230 may include, for example, a transmitter that may convert baseband signals from processor 200 to radio frequency (RF) signals and/or a receiver that may convert RF signals to baseband signals. Alternatively, communication interface 230 may include a transceiver to perform functions of both a transmitter and a receiver. Communication interface 230 may connect to antenna assembly 240 for transmission and/or reception of the RF signals.

Antenna assembly 240 may include one or more antennas to transmit and/or receive RF signals over the air. Antenna assembly 240 may, for example, receive RF signals from communication interface 230 and transmit them over the air, and receive RF signals over the air and provide them to communication interface 230. In one implementation, for example, communication interface 230 may communicate with a network and/or devices connected to a network.

As will be described in detail below, device 100 may perform certain operations described herein in response to processor 200 executing software instructions of an application contained in a computer-readable medium, such as memory 210. A computer-readable medium may be defined as a physical or logical memory device. A logical memory device may include memory space within a single physical memory device or spread across multiple physical memory devices. The software instructions may be read into memory 210 from another computer-readable medium or from another device via communication interface 230. The software instructions contained in memory 210 may cause processor 200 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 100, in other implementations, device 100 may contain fewer, different, differently arranged, or additional components than depicted in FIG. 2. In still other implementations, one or more components of device 100 may perform one or more other tasks described as being performed by one or more other components of device 100.

FIG. 3 depicts a diagram of exemplary components of display 130 of device 100. As shown, display 130 may include a light source 300, a screen 310, and/or a sensing layer 320.

Light source 300 may include a mechanism (e.g., a backlight) that provides backlighting to a lower surface of screen 310 in order to display information. For example, light source 300 may include one or more incandescent light bulbs, one or more light-emitting diodes (LEDs), an electroluminescent panel (ELP), one or more cold cathode fluorescent lamps (CCFL), one or more hot cathode fluorescent lamps (HCFL), etc. that illuminate portions of screen 310. Incandescent light bulbs may be used when very high brightness is desired. LEDs may be used in small, inexpensive lighting arrangements, and may include colored or white light. An ELP may be used for larger lighting arrangements or when even lighting is desired, and may be either colored or white. CCFLs may be used in large lighting arrangements and may be white in color. In another example, light source 300 may employ one or more diffusers or light guides to provide even lighting from an uneven source. In still another example, light source 300 can include any color light source (e.g., yellow, green, blue, white, etc.) or any combination of colored/non-colored light sources. The light provided by light source 300 may also be used to provide front lighting to an upper surface of screen 310 that faces a user.

Screen 310 may include any mechanism capable of providing visual information (e.g., text, images, video, incoming or outgoing calls, games, phone books, the current time, emails, etc.) to a user. For example, screen 310 may include a liquid crystal display (LCD), such as a thin film transistor (TFT) LCD, etc. In one exemplary implementation, screen 310 may include a plastic substrate that arranges TFT on a metal foil (rather than on glass), which may permit screen 310 to recover its original shape after being bent. Screen 310 may include a color filter coated onto the plastic substrate, which may permit screen 310 to display color images. In other implementations, screen 310 may include a monochrome LCD.

Sensing layer 320 may include a mechanism that detects the presence of an input object 330 (e.g., a user's finger, a stylus, etc.) on display 130, detects the location (or touch area) of input object 330 on display 130, determines how many fingers a user has on display 130, etc. For example, sensing layer 320 may include a layer of capacitive material (e.g., provided under a protective covering (not shown)) that may experience a change in electrical charges (e.g., a change in the amount of charge stored) when finger 330 contacts sensing layer 320. In one exemplary implementation, sensing layer 320 may include self capacitance circuitry that includes an array of electrodes and monitors changes in the array of electrodes when a user contacts sensing layer 320 (e.g., with finger 330). In another exemplary implementation, sensing layer 320 may include a layer of driving lines that carry current, and a separate layer of sensing lines that detect changes in electrical charge when a user contacts sensing layer 320.

Sensing layer 320 may sense a change associated with its electrical properties every time a user contacts sensing layer 320, and may provide this information to processor 200 and/or memory 210. Processor 200 may utilize this information to determine a shape, a size, and/or a location of a user's finger (or fingers) on display 130.

Although FIG. 3 shows exemplary components of display 130, in other implementations, display 130 may contain fewer, different, differently arranged, or additional components than depicted in FIG. 3. In still other implementations, one or more components of display 130 may perform one or more other tasks described as being performed by one or more other components of display 130.

### Exemplary Multimedia Module Input/Output Devices

FIGS. 4A-4F illustrate diagrams of exemplary configurations of multimedia module 160 of device 100. As shown in FIG. 4A, if touch screen device 110 is moved (e.g., slid) in a direction 400 (e.g., along a length of multimedia module 160), a keypad 410 of multimedia module 160 (e.g., stored under touch screen device 110) may be revealed. Keypad 410 may include gaming keys 420, keys 430, and/or other input mechanisms (e.g., a pointer device, a touch pad, a camera, etc.).

Keypad 410 may include control buttons that permit the user to interact with device 100 to cause device 100 to perform one or more operations. For example, the control buttons may be used for gaming, for performing multimedia functions (e.g., manipulate and/or capture video, audio, and/or images, playing music, etc.), etc. Keypad 410 may also include a standard telephone keypad, a QWERTY keyboard (or a portion of a QWERTY keyboard), etc. In one implementation, keypad 410 may provide functionality that is not provided (or easily used) via touch screen device 110.

Gaming keys 420 may include keys used for gaming, such as a joystick, a pointer device, a touch pad, etc. Keys 430 may include keys used for gaming, for performing multimedia functions, for activating other functions (e.g., telephone functions, video functions, music functions, etc.) of touch screen device 110, etc.

As shown in FIG. 4B, keypad 410 may be moved in a direction 440 (e.g., upwards and outwards) outside and above touch screen device 110. Keypad 410 may attach to multimedia module 160 via a mechanism (e.g., hinges, bearings, etc.) that enables keypad 410 to move in direction 440 outside and above touch screen device 110. As shown in FIG. 4C, if keypad 410 is provided outside and above touch screen device 110, touch screen device 110 may be moved (e.g., slid) in a direction 450 (e.g., the opposite of direction 400 (FIG. 4A)) so that touch screen device 110 is provided under keypad 410. This may lock keypad 410 above touch screen device 110.

As shown in FIG. 4D, if touch screen device 110 continues to be moved (e.g., slid) in direction 450 (e.g., along the length of multimedia module 160), a keypad 460 of multimedia module 160 (e.g., stored under touch screen device 110) may be revealed. Keypad 460 may include gaming keys 470, keys 480, and/or other input mechanisms (e.g., a pointer device, a touch pad, a camera, etc.).

Keypad 460 may include control buttons that permit the user to interact with device 100 to cause device 100 to perform one or more operations. For example, the control buttons may be used for gaming, for performing multimedia functions (e.g., manipulate and/or capture video, audio, and images, playing music, etc.), etc. Keypad 460 may also include a standard telephone keypad, a QWERTY keyboard (or a portion of a QWERTY keyboard), etc. In one implementation, keypad 460 may provide functionality that is not provided (or easily used) via touch screen device 110.

Gaming keys 470 may include keys used for gaming, such as a joystick, a pointer device, a touch pad, etc. Keys 480 may include keys used for gaming, for performing multimedia functions, for activating other functions (e.g., telephone functions, video functions, music functions, etc.) of touch screen device 110, etc.

As shown in FIG. 4E, keypad 460 may be moved in a direction 490 (e.g., upwards and outwards) outside and above touch screen device 110. Keypad 460 may attach to multimedia module 160 via a mechanism (e.g., hinges, bearings, etc.) that enables keypad 460 to move in direction 490 outside and above touch screen device 110. If keypad 410 is provided outside and above touch screen device 110, touch screen device 110 may be moved (e.g., slid) in direction 400 (e.g., along the length of multimedia module 160) again so that touch screen device 110 is provided under keypad 460, as shown in FIG. 4F. This may lock keypad 460 above touch screen device 110. In one implementation, touch screen device 110 may be provided below a portion of keypad 410 and below a portion of keypad 460.

In the arrangement shown in FIG. 4F, device 100 may be used for a variety of multimedia purposes. In one example, touch screen device 110 may display a game (e.g., via display 130) and keypads 410 and 460 may be used by a user of device 100 to perform functions associated with the game. In another example, touch screen device 110 may display the same game or a different game (e.g., via display 130), keypad 410 may be used by one user of device 100 to perform functions associated with the game, and keypad 460 may be used by another user of device 100 to perform functions associated with the game. In this example, the game may be a two player type of game that requires each player to operate a different game controller (e.g., keypads 410 and 460). In still another example, one or more of keypads 410 and 460 may be replaced with speakers and touch screen device 110 may display a music player (e.g., via display 130) that is capable of playing music (e.g., stored on device 100). The speakers may provide stereo quality sound for the music played by device 100. In a further example, one or more of keypads 410 and 460 may include one or more speakers, in addition to gaming keys 420, keys 430, gaming keys 470, and keys 480, provided on one or more portions of keypads 410 and 460.

Although FIGS. 4A-4F show exemplary components and configurations of multimedia module 160, in other implementations, multimedia module 160 may contain fewer, different, differently arranged, or additional components than depicted in FIGS. 4A-4F. In still other implementations, one or more components of multimedia module 160 may perform one or more other tasks described as being performed by one or more other components of multimedia module 160.

FIG. 5A depicts a diagram of an exemplary top plan view of device 100. As shown, device 100 may include touch screen device 110, multimedia module 160, keypad 410, and a speaker 500. Touch screen device 110 and multimedia module 160 may include the features described above in connection with, for example, FIGS. 1-4F.

Keypad 410 may include the features described above in connection with, for example, FIGS. 4A-4F. As further shown in FIG. 5A, keypad 410 may include a pointer 510, a touch pad 520, a camera 530, and keys 540. Pointer 510 may include an input device (e.g., a pointing stick, a trackball, etc.) used to move a pointer (or cursor) on display 130 of touch screen device 110, to perform functions associated with a game provided by touch screen device 110, etc. Touch pad 520 may include a flat surface that detects contact (e.g., from input object 330 (FIG. 3)), generates a mouse click via a tapping contact, senses contact pressure, senses special gestures (e.g., scrolling via movement of a finger along an edge), etc. Camera 530 may include a device that may capture and store images and/or video. For example, camera 530 may include a digital camera that captures and stores images and/or video electronically instead of using photographic film as in contemporary cameras. Camera 530 may be multifunctional and may be capable of recording sound and/or video, as well as images. Keys 540 may include keys used for gaming, for performing multimedia functions, for activating other functions (e.g., telephone functions, video functions, music functions, etc.) of touch screen device 110, etc.

Speaker 500 may include a device that converts analog audio signals into equivalent air vibrations in order to make audible sound. Speaker 500 may provide audible information to a user of device 100. Speaker 500 may function as a hands-free audio device when a user is engaged in a communication session using device 100. Speaker 500 may also function as an output device for music and/or audio information associated with games and/or video images played on device 100. In one implementation, keypad 410 may be replaced with another speaker 500, and speakers 500 may provide stereo sound to a user of device 100.

In one exemplary implementation, keypad 410 may be a touch screen device (e.g., similar to touch screen device 110) that provides input mechanisms (e.g., soft touch keys) that may change according to an application that is displayed on touch screen device 110. For example, if touch screen device 110 is displaying a movie, keypad 410 may display movie-related keys, such as play, pause, stop, volume, etc. keys. If touch screen device 110 is displaying a game, keypad 410 may display game-related keys, such as up, down, left, right, and other gaming-related keys. In such an arrangement, a user of device 100 may configure how keypad 410 changes based on the application that is displayed on touch screen device 110.

FIG. 5B illustrates a diagram of an exemplary front view of device 100, taken along line 5B-5B of FIG. 5A. FIG. 5C depicts a diagram of an exemplary side view of device 100, taken along line 5C-5C of FIG. 5A. As shown in FIGS. 5B and 5C, keypad 410 and speaker 500 may be provided above and partially outside of touch screen device 110. By providing keypad 410 and speaker 500 above and partially outside of touch screen device 110, device 100 may be used for a variety of multimedia purposes, as described above in connection with FIG. 4F.

Although FIGS. 5A-5C show exemplary components and configurations of device 100, in other implementations, device 100 may contain fewer, different, differently arranged, or additional components than depicted in FIGS. 5A-5F. In still other implementations, one or more components of device 100 may perform one or more other tasks described as being performed by one or more other components of device 100.

### Exemplary Process

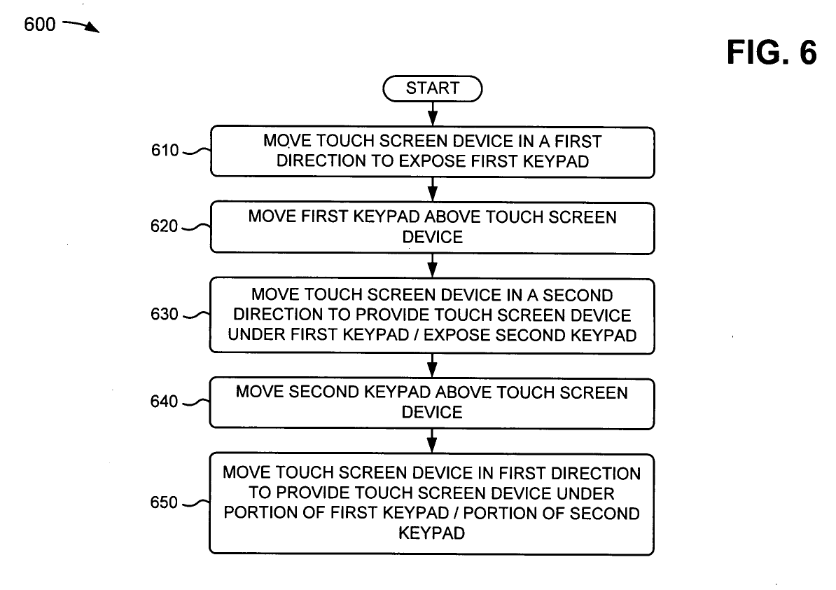

FIG. 6 illustrates a flow chart of an exemplary process 600 for interacting with device 100 according to implementations described herein. In one implementation, process 600 may be performed by one or more components of device 100.

As illustrated in FIG. 6, process 600 may begin with moving a touch screen device in a first direction to expose a first keypad (block 610), and moving the first keypad above the touch screen device (block 620). For example, in implementations described above in connection with FIGS. 4A and 4B, if touch screen device 110 of device 100 is moved (e.g., slid) in direction 400 (e.g., along a length of multimedia module 160), keypad 410 of multimedia module 160 (e.g., stored under touch screen device 110) may be revealed. Keypad 410 may include gaming keys 420, keys 430, and/or other input mechanisms (e.g., a pointer device, a touch pad, a camera, etc.). Keypad 410 may be moved in direction 440 outside and above touch screen device 110. Keypad 410 may attach to multimedia module 160 via a mechanism (e.g., hinges, bearings, etc.) that enables keypad 410 to move in direction 440 outside and above touch screen device 110.

As further shown in FIG. 6, the touch screen device may be moved in a second direction (opposite to the first direction) to provide the touch screen device under the first keypad and to expose a second keypad (block 630), and the second keypad may be moved above the touch screen device (block 640). For example, in implementations described above in connection with FIGS. 4D and 4E, if touch screen device 110 continues to be moved (e.g., slid) in direction 450 (e.g., along the length of multimedia module 160), keypad 460 of multimedia module 160 (e.g., stored under touch screen device 110) may be revealed. Keypad 460 may include gaming keys 470, keys 480, and/or other input mechanisms (e.g., a pointer device, a touch pad, a camera, etc.). Keypad 460 may be moved in direction 490 outside and above touch screen device 110. Keypad 460 may attach to multimedia module 160 via a mechanism (e.g., hinges, bearings, etc.) that enables keypad 460 to move in direction 490 outside and above touch screen device 110.

Returning to FIG. 6, the touch screen device may be moved in the first direction to provide the touch screen device under a portion of the first keypad and under a portion of the second keypad (block 650). For example, in implementations described above in connection with FIG. 4F, if keypad 410 is provided outside and above touch screen device 110, touch screen device 110 may be moved (e.g., slid) in direction 400 (e.g., along the length of multimedia module 160) again so that touch screen device 110 is provided under keypad 460. This may lock keypad 460 above touch screen device 110. In one example, touch screen device 110 may be provided below a portion of keypad 410 and below a portion of keypad 460.

Systems and/or methods described herein may enhance a multimedia and/or gaming experience for a user of a mobile communication device that may include a touch screen device. In one implementation, for example, the systems and/or methods may move a touch screen device (e.g., of a mobile communication device) in a first direction to expose a first keypad, and may move the first keypad above the touch screen device. The systems and/or methods may move the touch the screen device in a second direction to provide the touch screen device under the first keypad and to expose a second keypad, and may move the second keypad above the touch screen device. The systems and/or methods may move the touch screen device in the first direction to provide the touch screen device under a portion of the first keypad and under a portion of the second keypad.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 6, the order of the blocks may be modified in other implementations. Further, non-dependent blocks may be performed in parallel.

It should be emphasized that the term “comprises/comprising” when used in the this specification is taken to specify the presence of stated features, integers, steps or components but does not preclude the presence or addition of one or more other features, integers, steps, components or groups thereof.

It will be apparent that aspects, as described herein, may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware may be designed to implement these aspects based on the description herein.

Even though particular combinations of features are recited in the claims and/or disclosed in the specification, these combinations are not intended to limit the description of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A mobile communication device, comprising:
a touch screen device; and
a multimedia module that moveably connects to the touch screen device, where the multimedia module includes:
a first input or output mechanism provided at a first location of the multimedia module that is below the touch screen device, where the first input or output mechanism is moveable from the first location to above a first end portion of the touch screen device, and
a second input or output mechanism provided at a second location of the multimedia module that is below the touch screen device, where the second input or output mechanism is moveable from the second location to above a second end portion of the touch screen device.

2. The mobile communication device of claim 1, where the mobile communication device comprises one or more of:
a radiotelephone,
a personal communications system (PCS) terminal,
a personal digital assistant (PDA),
a portable gaming system, or
a global positioning system (GPS) device.

3. The mobile communication device of claim 1, where the touch screen device comprises:
a housing,
a display supported by the housing, and
a sensing layer to detect an input object.

4. The mobile communication device of claim 1, where the multimedia module is removable from the touch screen device.

5. The mobile communication device of claim 1, where, when the touch screen device is moved in a first direction, the first input or output mechanism is exposed and is moveable from the first location to above the first end portion of the touch screen device.

6. The mobile communication device of claim 5, where, when the touch screen device is moved in a second direction that is opposite to the first direction, the second input or output mechanism is exposed and is moveable from the second location to above the second end portion of the touch screen device.

7. The mobile communication device of claim 1, where the first input or output mechanism comprises a keypad.

8. The mobile communication device of claim 7, where the keypad includes one or more of:
one or more keys,
a pointer device,
a touch pad, or
a camera.

9. The mobile communication device of claim 1, where the first input or output mechanism comprises a speaker.

10. The mobile communication device of claim 1, where the second input or output mechanism comprises a keypad.

11. The mobile communication device of claim 10, where the keypad includes one or more of:
one or more keys,
a pointer device,
a touch pad, or
a camera.

12. The mobile communication device of claim 1, where the second input or output mechanism comprises a speaker.

13. A system, comprising:
a touch screen mobile communication device; and
a multimedia module that moveably connects to the touch screen mobile communication device, where the multimedia module includes:
a first input mechanism provided at a first location of the multimedia module that is below the touch screen mobile communication device, where the first input mechanism is moveable from the first location to above a first end portion of the touch screen mobile communication device, and
a second input mechanism provided at a second location of the multimedia module that is below the touch screen mobile communication device, where the second input mechanism is moveable from the second location to above a second end portion of the touch screen mobile communication device.

14. The system of claim 13, where the touch screen mobile communication device comprises one or more of:
a radiotelephone,
a personal communications system (PCS) terminal,
a personal digital assistant (PDA),
a portable gaming system, or
a global positioning system (GPS) device.

15. The system of claim 13, where the multimedia module is a removable and distinct component from the touch screen mobile communication device.

16. The system of claim 13, where, when the touch screen mobile communication device is moved in a first direction, the first input mechanism is exposed and is moveable from the first location to above the first end portion of the touch screen mobile communication device.

17. The system of claim 16, where, when the touch screen mobile communication device is moved in a second direction that is opposite to the first direction, the second input mechanism is exposed and is moveable from the second location to above the second end portion of the touch screen mobile communication device.

18. The system of claim 13, where each of the first input mechanism and the second input mechanism comprises a keypad that includes one or more of:
one or more keys,
a pointer device,
a touch pad, or
a camera.

19. A mobile communication device, comprising:
a touch screen device; and
a multimedia module that moveably connects to the touch screen device, where the multimedia module includes:
a first output mechanism provided at a first location of the multimedia module that is below the touch screen device, where the first output mechanism is moveable from the first location to above a first end portion of the touch screen device, and
a second output mechanism provided at a second location of the multimedia module that is below the touch screen device, where the second output mechanism is moveable from the second location to above a second end portion of the touch screen device.

20. The mobile communication device of claim 19, where each the first output mechanism and the second output mechanism comprises a speaker.
